(19) United States
(12) Patent Application Publication
(10) Pub. No.: US 2013/0060824 A1
(43) Pub. Date: Mar. 7, 2013

(54) SYSTEM FOR EMBEDDED KNOWLEDGE MANAGEMENT

(71) Applicants: Eitan Hadar, Nesher (IL); Meira Levy, K. Tivon (IL); Irit Hadar, Nesher (IL)

(72) Inventors: Eitan Hadar, Nesher (IL); Meira Levy, K. Tivon (IL); Irit Hadar, Nesher (IL)

(73) Assignee: Computer Associates Think, Inc., Islandia, NY (US)

(21) Appl. No.: 13/223,413

(22) Filed: Sep. 1, 2011

(51) Int. Cl. G06F 17/30

(52) U.S. Cl. 707/812; 707/E17.005

(57) ABSTRACT

A system includes a toolbar configured to receive a knowledge nugget relating to a software architecture. The knowledge nugget includes information relating to the software architecture, an identification of the creator of the knowledge nugget, a link to information relating to the knowledge nugget, a blog relating to the knowledge nugget, a tag to enable search and retrieval of the knowledge nugget, and a point of contact for discussion relating to the knowledge nugget. The toolbar is further configured to analyze the knowledge nugget, and to store the knowledge nugget in a transient database or a permanent database as a function of the analysis.

### TECHNICAL FIELD

The present disclosure relates to knowledge management systems.

### BACKGROUND

In many cases, software (and also hardware) architects do not systematically capture and reuse previous architecture solutions, lessons learned from former reviews, implementation experiences of their peers, and other relevant knowledge. Consequently, software architects keep “reinventing the wheel” for each solution, at times repeating mistakes that could have been avoided. This causes the software architecture design process, as well as the follow-up review process, to be long and inefficient. Moreover, having no embedded knowledge system in their working environment, architects are not motivated to contribute to a shared knowledge repository.

### SUMMARY

A system, a process, and a computer readable medium including instructions for a process, displays a toolbar. The toolbar is configured to enable a processor to receive a knowledge nugget relating to a software architecture. The knowledge nugget includes information relating to the software architecture, an identification of the creator of the knowledge nugget, a link to information relating to the knowledge nugget, a blog relating to the knowledge nugget, a tag to enable search and retrieval of the knowledge nugget, and a point of contact for discussion relating to the knowledge nugget. The processor is further enabled to analyze the knowledge nugget, and store the knowledge nugget in a transient database or a permanent database as a function of the analysis.

### BRIEF DESCRIPTION OF THE DRAWINGS

FIG. 1 illustrates various platforms for a knowledge nugget toolbar plug-in.

FIG. 2 illustrates an example model for a knowledge nuggets system.

FIG. 3 illustrates an example embodiment of front end and a back end of an embedded tool bar plug-in for a knowledge management system.

FIGS. 4A, 4B and 4C are a flowchart of an example process 400 for an embedded knowledge management system

FIG. 5 is a block diagram of an example embodiment of a computer system upon which one or more embodiments of the present disclosure can execute.

### DETAILED DESCRIPTION

In light of current software architecture design, review, and implementation processes, there is a need to provide methods and tools that will enable a systematic and efficient capturing and sharing of architecture knowledge. It would further be helpful if these methods and tools would be embedded in the natural working environment and process of the software architects and other stakeholders throughout the development lifecycle. Such a solution would foster communication between the various stakeholders, such as among software architects, between software architects and reviewers, and others involved in the development and implementation process. Addressing this need would reduce the time-to-value in making software architecture decisions and constructing the software architecture blueprint and documentation, while at the same time increasing the quality of the resulted architecture artifacts. This in turn would reduce time-to-market of information technology (IT) solutions and increase the quality of these solutions.

In an embodiment, an in-process embedded façade for technological knowledge management is implemented by an architecture knowledge nuggets toolbar and database. An architecture knowledge nugget is any piece of information or data relating to computer system software or hardware architecture. The embodiment can be implemented as a plug-in. It assists in documenting, reviewing, and communicating computer and software architecture knowledge, and addresses best practices, design patterns, review comments, and any additional architecture concern that is relevant during the life cycle of software product development, starting from marketing through implementation and testing, and can foster reuse of architecture artifacts. In an embodiment, knowledge is not scattered and not handled separately from the business process environment. Rather, via a toolbar for example, the system is embedded within the whole development process. In addition, the system can be a single point of entrance to other organizational systems.

An embodiment enables the embedding of a plug-in within any information system for handling knowledge about the information system. Utilizing knowledge reduces the time-to-value in making architecture decisions while increasing the quality of the resulted artifacts. The system can include tools to automate the production of architecture documentations and decisions, while reusing existing knowledge. The system further provides on-the-fly access to relevant information related to architectural design decisions, and the collection of best practices while practicing routine research and development and deployment activities. The system further supports the review process of the architecture and accumulates knowledge from previous reviews for the use of both architects and reviewers, and facilitates software engineering management.

An advantage of an embodiment is rapid software architecture design. Rapid software architecture design involves the ability to select from former software architecture solution parts or aspects that are relevant to a current software design problem or solution. This enables communication and sharing of knowledge throughout the software development process. It further provides integrity and accuracy through the reduction of effort and the retention of high integrity and accuracy by automating document creation. It provides knowledge association, that is, the ability to present a knowledge nugget describing the essence of software architecture decisions.

A system embodiment enables the embedding of knowledge within the working environments and processes that are using both knowledge contributor (the indication of who the contributor of each knowledge nugget is; a basis for quality evaluation by the user as well as a point of contact for further guidance or discussion) and architecture knowledge tagging (the tagging of free text knowledge items will enable search and retrieval options). A system embodiment further ensures knowledge creation segregation. That is, it ensures that only the right knowledge workers can contribute specific knowledge within the specific context/process of their task. In cases wherein generic knowledge is constructed, it is handled on dedicated, open knowledge systems, and accordingly, reduces the level of trust of the generated knowledge. A system embodiment further ensures efficient knowledge purification, which is based on workflow automatic rules and identity management. According to the creation segregation, knowledge nuggets can be approved automatically. For example, a knowledge nugget created by the acting software architect or lead designer can be approved automatically, whereas a contribution of a novice software architect knowledge can be heavily analyzed and scrutinized before being retained as a knowledge nugget in a permanent database.

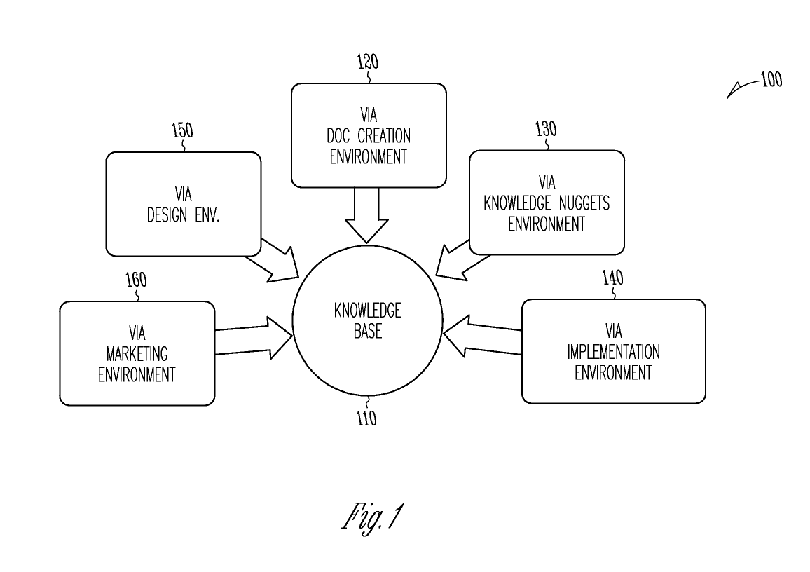

FIG. 1 illustrates various platforms for a knowledge nugget toolbar plug-in 100. A knowledge base 110 can be supplied with knowledge nuggets via a design environment 150, via a document creation environment 120, and a knowledge nuggets environment 130. The design environment can include for example notes from design meetings of software architects. The document creation environment can include for example information within software architecture documents such as system documentation and user guides. The knowledge nuggets environment can include for example specific and particular information provided to the knowledge environment by a software architect. Information can additionally be supplied to the knowledge base 110 via a marketing environment 160 and an implementation environment 140. For example, a marketing department may become aware of a market need for a particular user interface or a particular look and feel of a user interface. When a software system is implemented, issues may arise, and/or knowledge may be acquired, which would be worthwhile to store in the knowledge base 110 for future use.

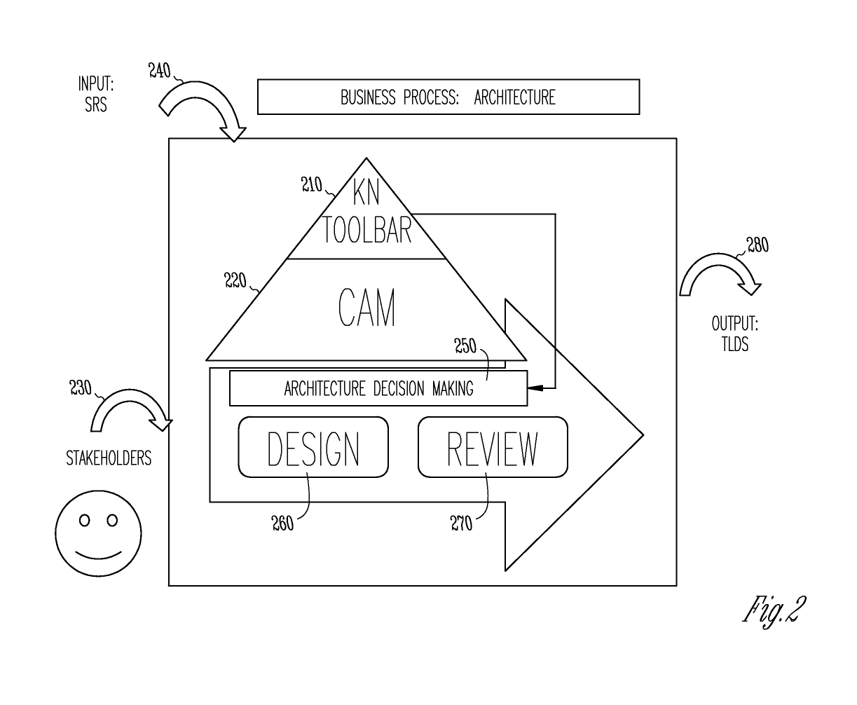

FIG. 2 illustrates an example model for a knowledge nuggets system. FIG. 2 shows how a knowledge nuggets toolbar 210 is plugged within an architecture modeling tool 220 and used during the architecture design embedded in an architecture management environment 220. Specifically, the toolbar 210 sits on top of the architecture management environment 220. Input can be received from stakeholders 230 and/or a software requirements specification (SRS) 240. The toolbar 210 assists in the software architecture decision making at 250, which involves processes of design 260 and review 270. The result is a top level design specification (TLDS) 280.

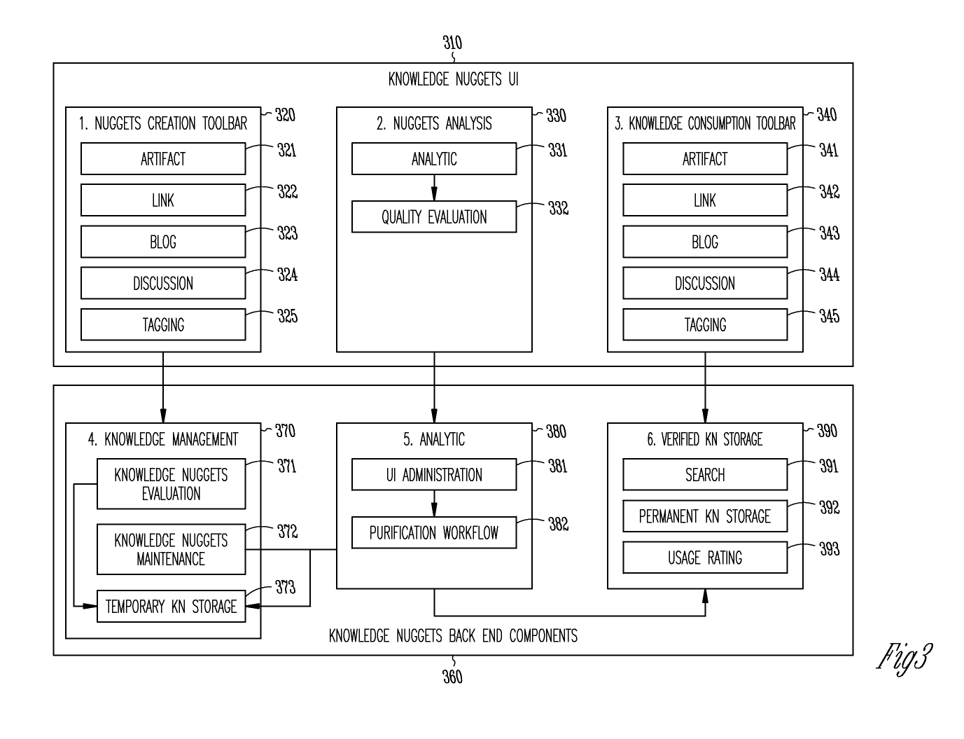

FIG. 3 illustrates an example embodiment of front end 310 and a back end 360 of an embedded tool bar plug in for a knowledge management system. The icons in FIG. 3 trigger opening sub-menus for functional capabilities, which are explained below using examples and use cases. The front end and back end tool bar includes the following components.

A nuggets creation toolbar 210 is a means by which to create temporary content that is to be purified (that is, analyzed and reviewed and approved before being placed into a permanent storage). The toolbar includes an artifact 321, a link 322, a Blog 323, a discussion icon 324, and a tagging icon 325. The separate components enable user access control, managing privileges for knowledge construction within a process, product, and domain (e.g., only the architect of a product, can change the product relevant information). Thus segregation of duties is maintained, thereby increasing the level of trust on the generated knowledge quality.

The artifact 321 handles tangible knowledge artifacts such as standards, design patterns, patents and other intellectual property information, and evaluations regarding specific information (e.g. rational of a design decision, tips, tricks). It can also contain additional related information. The link 322 handles linkage pointers to organizational information systems such as a document in a repository, a record in a wiki system, a component in a components catalog, and an architecture document (e.g. a top level design document—TLDS). The Blog 323 handles a diary regarding the specific information at hand. For example, the Blog can include a software architect's diary. The Blog can reside within the architecture modeling tool, wherein design comments and project related notes can be stored. The discussion icon 324 handles stakeholders' discussions regarding specific information at hand. For example, a discussion can relate to reviewers' comments regarding a design solution. The tagging icon 325 handles tagging creation and use for tagging unstructured knowledge.

The Nuggets Analysis icon 330 includes an analytics icon 331 and a quality evaluation icon 332. The quality evaluation icon 332 is the user interface portion of the toolbar 310 that enables the definitions of reviewers and purification workflow of transient knowledge nuggets in the contribution components. It further enables migrating of the purified (i.e., changed) knowledge to the permanent nuggets store. This includes the ability to eliminate knowledge both on the transient as well as the permanent knowledge stores. In case the knowledge was constructed by an identified, privileged user, within known tools and phases of the process, the system can recommend a rapid knowledge approval, significantly reducing the amount of knowledge purification labor. In an embodiment, manual approval and purification can always be conducted. The analytics icon 331 is implemented either by statistical methods, or by the polling of the personnel who are involved with a particular software architecture. An example of the use of a statistical method is statistics of how a specific knowledge nugget was evaluated on a scale of 1 to 5, or statistics regarding the most accessed nuggets. The polling of people is aimed at rating contributed knowledge, and enables the community to improve and expand new information to the nuggets.

The knowledge consumption toolbar 340 enables the searching of purified, high quality content of the artifact 341, the link 342, the Blog 343, the discussion 344, and the tagging 345. The separate component usually does not prohibit user access control, although it can do so when needed, and can be provided in any embedded system as a regular façade for the information. As one can see, the icons are the same as the creation toolbar 320, yet the knowledge consumption toolbar 340 only enables searching purified, high-quality content of the artifact, link, Blog, discussion, and tagging after it has been moved to the permanent knowledge store following analysis.

The backend portion 360 of the toolbar 310 includes a knowledge management icon 370, an analytic icon 380, and a verified knowledge nugget data store 390. The knowledge management 370 includes knowledge nuggets evaluation 371, knowledge nuggets maintenance 372, and temporary knowledge nuggets storage 373. The knowledge nuggets evaluation handles the created knowledge nuggets evaluation. Specifically, it is used for getting feedback from the various stakeholders regarding the importance and accuracy of the captured knowledge nugget. The knowledge nugget maintenance 372 handles knowledge purification for ensuring the quality of the captured knowledge. The temporary knowledge nugget storage 373 contains all the nuggets contributed by the community—prior to being approved and placed in permanent storage. The data in the temporary knowledge nugget storage 373 are pending analysis. After analysis, the data may be removed from the temporary store 373 and written to the permanent, verified data store.

The analytic interface 380 includes the user interface administration 381 and the purification workflow 382. The analytic interface 380 handles the mining of the knowledge nugget repository for displaying the statistics regarding the knowledge nugget and contributors. This feature can serve as a motivation trigger for knowledge contributions. The user interface administration 381 handles the plug-in components so more options for knowledge capturing will be added or removed. In addition, fixed information will also be handled (i.e., URLs of the information systems) so that the user will not need to look for the information while using the system. The purification workflow 382 can include a workflow of the steps required for data to be purified and eligible for storage in the permanent data store.

The verified knowledge nugget storage 390 includes a search 391, permanent storage 392, and usage rating 393. The search icon 391 permits search of the storage 392. The search 391 handles search options for finding knowledge nuggets according to free text, specific nuggets (i.e. artifact, evaluations) or tags. The usage rating 393 includes information relating to the amount of usage the permanent knowledge nugget storage 392 incurs.

An example of the usage of the toolbar 310 is as follows. For example, the marketing department may discover a new need regarding a particular software protocol standard. A marketing employee will be able to insert an artifact regarding this new standard, including all relevant information. A software designer may want to link the new standard artifact, which was created by the marketing department, to the design artifact. During the implementation phase, a problem may occur that resulted in a need to change the software architecture design. An implementer can add retrospective evaluation to the software architecture document within the knowledge nugget, through the implementation and analytics components.

A user will create a knowledge nugget identified with a name to identify the new standard information. This named knowledge nugget will be created via the artifact option 321 in the knowledge nugget creation toolbar 320. All relevant material from different sources will be linked to the knowledge nugget via the link option 322, including—where relevant—a blog 323 related to this topic. There is also a possibility to discuss (324) the knowledge nugget for evaluation and enhancement. Finally, the knowledge nugget is tagged (325) (e,g, protocol, standard).

Thereafter, the knowledge nugget will be analyzed and evaluated. Should the user who inserted the knowledge nugget be a privileged user (e.g. the lead architect of the related product or a product related to the new protocol standard), the knowledge nugget can be automatically approved. Otherwise, experts in the protocol standard will be allocated for the purification workflow for evaluating and refining the new knowledge nugget.

The software architect will then design a solution that supports the new protocol standard. For linking the solution with the explanation what the new standard means, the software architect, while for example designing a solution on the software architecture modeling environment, can click on the artifact 321 and the standard options therein, and chooses the newly named standard to be linked with the current solution. After the linkage is set, it can be used to automatically integrate it within the design document, or it can facilitate other stakeholders' understanding of the concept of the new protocol standard.

As described above, an embodiment of the knowledge management system addresses challenges in knowledge capturing and reuse during software architecture activities and throughout the software development process. It efficiently reduces the amount of labor normally associated with knowledge construction, leveraging context, identities and authority as basic rules for rapid purification. It provides a systematic plug-in and method for capturing and reusing knowledge via the same look-and-feel tools that are probably already embedded in the working environment and process. Although targeted primarily for software architecture process improvement, the system is relevant for any technological management system by enabling a “divide-and-concur” approach that simplifies knowledge creation and consumption, thereby bringing the knowledge to be part of the regular working environment (such as a modeling tool), and not as commonly used today within dedicated knowledge system. Thus, an embodiment invention is an in-process, embedded façade for technological knowledge management.

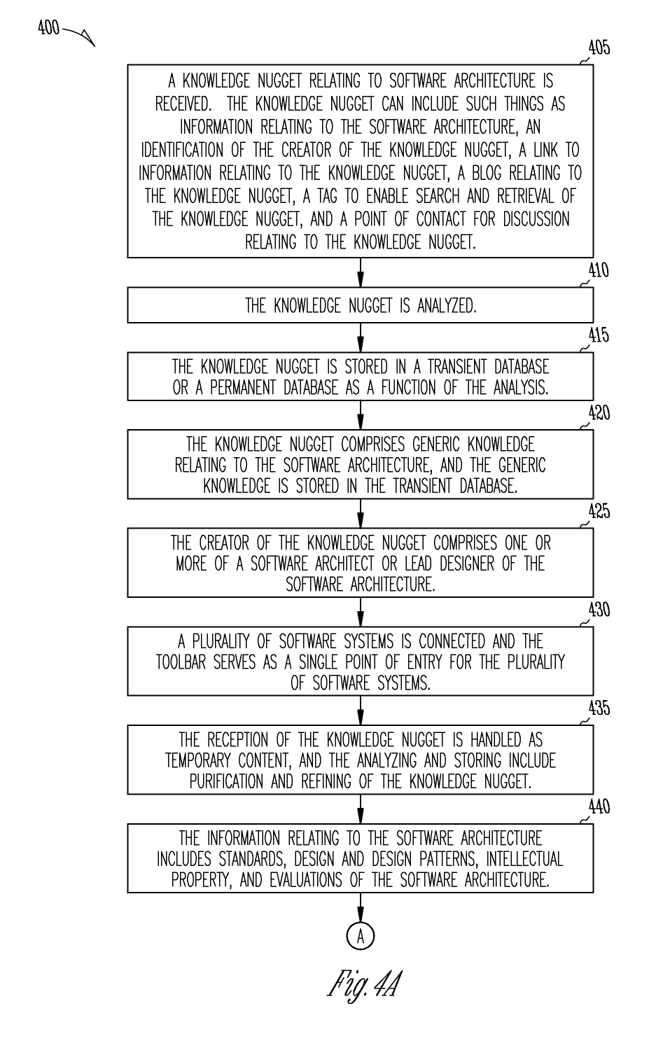

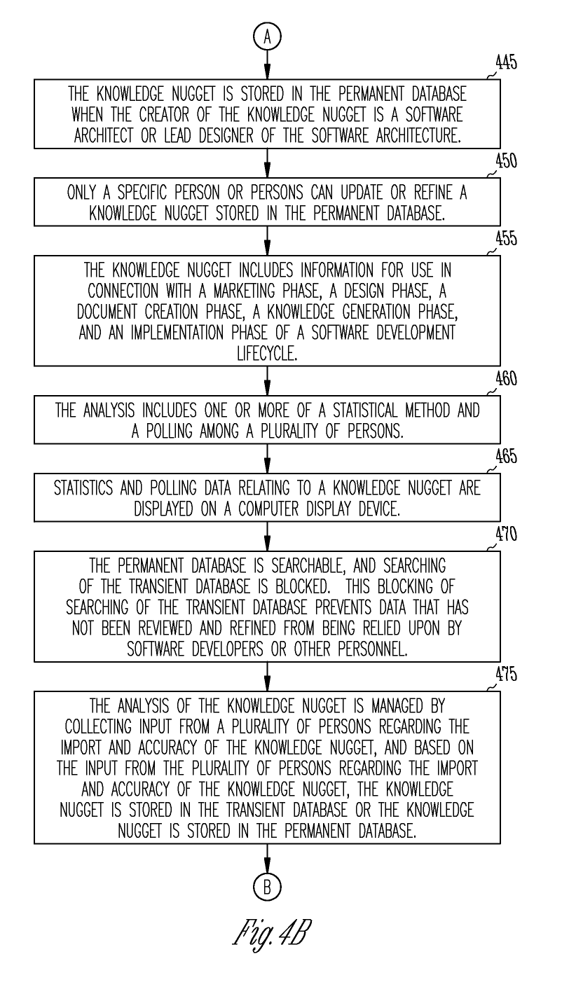

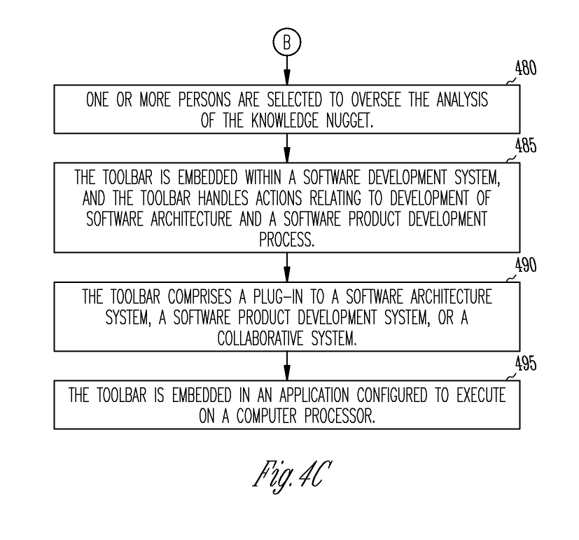

FIGS. 4A, 4B, and 4C are a flowchart of an example process 400 for an embedded knowledge management system. FIGS. 4A, 4B, and 4C include a number of process blocks 405-495. Though arranged serially in the example of FIGS. 4A, 4B, and 4C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIGS. 4A, 4B, and 4C, at 405, a knowledge nugget relating to software architecture is received. The knowledge nugget can include such things as information relating to the software architecture, an identification of the creator of the knowledge nugget, a link to information relating to the knowledge nugget, a blog relating to the knowledge nugget, a tag to enable search and retrieval of the knowledge nugget, and a point of contact for discussion relating to the knowledge nugget. At 410, the knowledge nugget is analyzed, and at 415, the knowledge nugget is stored in a transient database or a permanent database as a function of the analysis.

At 420, the knowledge nugget comprises generic knowledge relating to the software architecture, and the generic knowledge is stored in the transient database. At 425, the creator of the knowledge nugget comprises one or more of a software architect or lead designer of the software architecture. At 430, a plurality of software systems is connected and the toolbar serves as a single point of entry for the plurality of software systems. At 435, the reception of the knowledge nugget is handled as temporary content, and the analyzing and storing include purification and refining of the knowledge nugget. At 440, the information relating to the software architecture includes standards, design and design patterns, intellectual property, and evaluations of the software architecture.

At 445, the knowledge nugget is stored in the permanent database when the creator of the knowledge nugget is a software architect or lead designer of the software architecture. At 450, only a specific person or persons can update or refine a knowledge nugget stored in the permanent database. At 455, the knowledge nugget includes information for use in connection with a marketing phase, a design phase, a document creation phase, a knowledge generation phase, and an implementation phase of a software development lifecycle. At 460, the analysis includes one or more of a statistical method and a polling among a plurality of persons. At 465, statistics and polling data relating to a knowledge nugget are displayed on a computer display device. At 470, the permanent database is searchable, and searching of the transient database is blocked. This blocking of searching of the transient database prevents data that has not been reviewed and refined from being relied upon by software developers or other personnel.

At 475, the analysis of the knowledge nugget is managed by collecting input from a plurality of persons regarding the import and accuracy of the knowledge nugget, and based on the input from the plurality of persons regarding the import and accuracy of the knowledge nugget, the knowledge nugget is stored in the transient database or the knowledge nugget is stored in the permanent database. At 480, one or more persons are selected to oversee the analysis of the knowledge nugget. At 485, the toolbar is embedded within a software development system, and the toolbar handles actions relating to development of software architecture and a software product development process. At 490, the toolbar comprises a plug-in to a software architecture system, a software product development system, or a collaborative system. At 495, the toolbar is embedded in an application configured to execute on a computer processor.

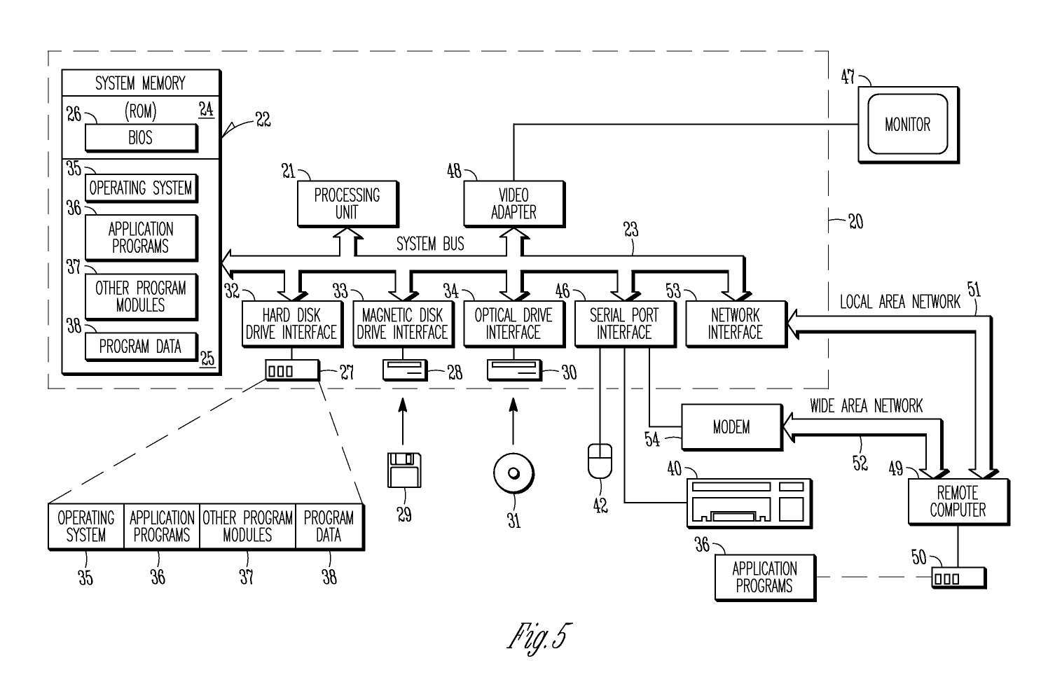

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Thus, an example system, method and machine readable medium for implementing an embedded knowledge management system have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor configured to display a toolbar, the toolbar configured to enable the processor to:
receive a knowledge nugget relating to a software architecture, the knowledge nugget comprising information relating to one or more of the software architecture, an identification of the creator of the knowledge nugget, a link to information relating to the knowledge nugget, a blog relating to the knowledge nugget, a tag to enable search and retrieval of the knowledge nugget, and a point of contact for discussion relating to the knowledge nugget;
analyze the knowledge nugget; and
store the knowledge nugget in a transient database or a permanent database as a function of the analysis.

2. The system of claim 1, wherein the knowledge nugget comprises generic knowledge relating to the software architecture, and wherein the computer processor is configured to store the generic knowledge in the transient database.

3. The system of claim 1, wherein the creator comprises one or more of a software architect or lead designer of the software architecture.

4. The system of claim 1, wherein the computer processor is configured to connect a plurality of software systems and to act as a single point of entry for the plurality of software systems.

5. The system of claim 1, wherein the computer processor is configured to handle the reception of the knowledge nugget as temporary content, and wherein the analyzing and storing comprise a purification and refining of the knowledge nugget.

6. The system of claim 1, wherein the information relating to the software architecture comprises standards, design and design patterns, intellectual property, and evaluations of the software architecture.

7. The system of claim 1, wherein the computer processor is configured to store the knowledge nugget in the permanent database when the creator of the knowledge nugget is a software architect or lead designer of the software architecture.

8. The system of claim 1, wherein the computer processor is configured such that only a specific person or persons can update or refine a knowledge nugget stored in the permanent database.

9. The system of claim 1, wherein the knowledge nugget comprises information for use in connection with a marketing phase, a design phase, a document creation phase, a knowledge generation phase, and an implementation phase of a software development lifecycle.

10. The system of claim 1, wherein the analysis comprises one or more of a statistical method and a polling among a plurality of persons.

11. The system of claim 10, wherein the computer processor is configured to display statistics and polling data relating to a knowledge nugget.

12. The system of claim 1, wherein the computer processor is configured to search the permanent database and to block searching of the transient database.

13. The system of claim 1, wherein the computer processor is configured to manage the analysis of the knowledge nugget by collecting input from a plurality of persons regarding the import and accuracy of the knowledge nugget.

14. The system of claim 13, wherein, based on the input from the plurality of persons regarding the import and accuracy of the knowledge nugget, the knowledge nugget is stored in the transient database or the knowledge nugget is stored in the permanent database.

15. The system of claim 1, wherein the computer processor is configured to select one or more persons to oversee the analysis of the knowledge nugget.

16. The system of claim 1, wherein the computer processor is embedded within a software development system, and wherein the computer processor is configured to handle actions relating to development of a software architecture and a software product development process.

17. The system of claim 1, wherein the toolbar comprises a plug-in to a software architecture system, a software product development system, or a collaborative system.

18. The system of claim 1, wherein the toolbar is embedded in an application configured to execute on the computer processor.

19. A computer-readable medium comprising instructions that when executed by a processor executes a process comprising:
receiving a knowledge nugget relating to a software architecture, the knowledge nugget comprising information relating to one or more of the software architecture, an identification of the creator of the knowledge nugget, a link to information relating to the knowledge nugget, a blog relating to the knowledge nugget, a tag to enable search and retrieval of the knowledge nugget, and a point of contact for discussion relating to the knowledge nugget;
analyzing the knowledge nugget; and
storing the knowledge nugget in a transient database or a permanent database as a function of the analysis.

20. The computer-readable medium of claim 19, comprising instructions for connecting a plurality of software systems and to act as a single point of entry for the plurality of software systems.

21. The computer-readable medium of claim 19, comprising instructions for handling the reception of the knowledge nugget as temporary content, wherein the instructions for analyzing and storing comprise a purification and refining of the knowledge nugget.

22. The computer-readable medium of claim 19, wherein the information relating to the software architecture comprises standards, design and design patterns, intellectual property, and evaluations of the software architecture.

23. The computer-readable medium of claim 19, comprising instructions for managing the analysis of the knowledge nugget by collecting input from a plurality of persons regarding the import and accuracy of the knowledge nugget; and
instructions for storing the knowledge nugget in the transient database or the permanent database as a function of the input from the plurality of persons regarding the import and accuracy of the knowledge nugget.

24. The computer-readable medium of claim 19, wherein the instructions are embedded within a software development system, and comprising instructions for handling actions relating to development of a software architecture and a software product development process.

25. The computer-readable medium of claim 19, wherein the toolbar comprises a plug-in to a software architecture system, a software product development system, or a collaborative system.

26. The computer-readable medium of claim 19, wherein the toolbar is embedded in a software application.

27. A process comprising:
receiving into a computer storage medium a knowledge nugget relating to a software architecture, the knowledge nugget comprising information relating to one or more of the software architecture, an identification of the creator of the knowledge nugget, a link to information relating to the knowledge nugget, a blog relating to the knowledge nugget, a tag to enable search and retrieval of the knowledge nugget, and a point of contact for discussion relating to the knowledge nugget;
analyzing with a computer processor the knowledge nugget; and
storing the knowledge nugget in a transient database or a permanent database as a function of the analysis.
